(19) United States
(12) Patent Application Publication
(10) Pub. No.: US 2005/0233120 A1
(43) Pub. Date: Oct. 20, 2005

(54) Image laminate apparatus and method

(75) Inventor: Timothy E. Campbell, Dalton, GA (US)

Correspondence Address: HUSCH & EPPENBERGER, LLC, 190 CARONDELET PLAZA, SUITE 600, ST. LOUIS, MO, 63105-3441, US

(73) Assignee: Campbell Printing Company, Dalton, GA (US)

(21) Appl. No.: 10/825,050

(22) Filed: Apr. 15, 2004

(51) Int. Cl. B32B 31/00

(52) U.S. Cl. 428/201; 156/297

(57) ABSTRACT

An image laminate including a backing layer; an ink layer over a portion of a top surface of the back layer, the ink layer comprising an image; a polymer layer over at least the ink layer; a boundary material substantially circumscribing the ink layer, the boundary material being deposited on a top surface of the polymer layer; and a polyurethane lens also on the top surface of the polymer layer, the polyurethane lens being substantially over the ink layer and substantially within the boundary material.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention is in the field of laminated display materials, particularly floor covering sample vehicles.

2. Related Art

The marketing of building surfaces materials, especially floor coverings, has traditionally relied upon sample books both at the wholesale and resale levels. Sample books have traditionally incorporated actual pieces of material, for example small pieces of carpet known as “swatches.” Floor covering display vehicles relying on display of actual swatches of material have disadvantages, including weight, bulk, time to assemble and expense. These problems are common to both display books and room displays. In the case of sample books, floor coverings, such as tile, linoleum or wood, can be prohibitively cumbersome to display.

Prior art display vehicles, such as those disclosed in U.S. Pat. No. 5,316,138 to Thomson, and U.S. Pat. No. 6,186,327 to Hadden do not address the fundamental problems with sample vehicles because they continue to rely on actual pieces of floor covering material. Hence, there remains a need in the art for a display vehicle comprised of two dimensional images, usually photographs, of building interior surface coverings, a backing for the images that is amenable for use in either sample books or store displays, and an outer covering to fix the images on the backing. There is further need for a material that can be laminated over the images to impart a three dimensional effect to give the viewer a reasonable impression of appearance of the surface covering display.

Laminated articles for display of materials, for example, labels or name tags, are known in the prior art. For example, U.S. Pat. No. 6,263,598 to Sullivan discloses such a laminated product with a polyurethane dome. However, such prior art laminates are not usefully applied to floor covering sample displays. They typically do not have a base layer of paper, but rather seldom used plastic substrates. Accordingly, most print shops used in the building supply display industry could not execute such prior art devices. Moreover, the ink of the image in laminate such as that disclosed in Sullivan is exposed to scratching and other damage during the production process. Finally, label and tag laminated articles are organized in systems for printing identical images multiple times on single sheets so that they can be removed and applied as identical labels or tags to a repetitive item such as a name tag base or a product label. Accordingly, there are no preexisting systems for laminating and doming products wherein a single sheet contains multiple different images.

### SUMMARY OF THE INVENTION

It is in view of the above problems that the present invention was developed. The invention is an image laminate including a backing layer with an ink layer over a portion of a top surface of the backing layer. The ink layer comprises an image, usually a photograph. A film layer is over at least the ink layer in one embodiment. A boundary material substantially circumscribes the ink layer. The boundary material is deposited on a top surface of the film layer. A polyurethane lens is on the top surface of the film layer substantially over the ink layer and substantially within the boundary material.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a top view of the laminated display vehicle of the present invention;

FIG. 2 is a side view of the laminated display vehicle;

FIG. 3 is an exploded cross section of an embodiment using film laminate paper; and

FIG. 4 is an exploded cross section of an alternative embodiment using coated paper.

### DETAILED DESCRIPTION OF THE PREFERRED EMBODIMENTS

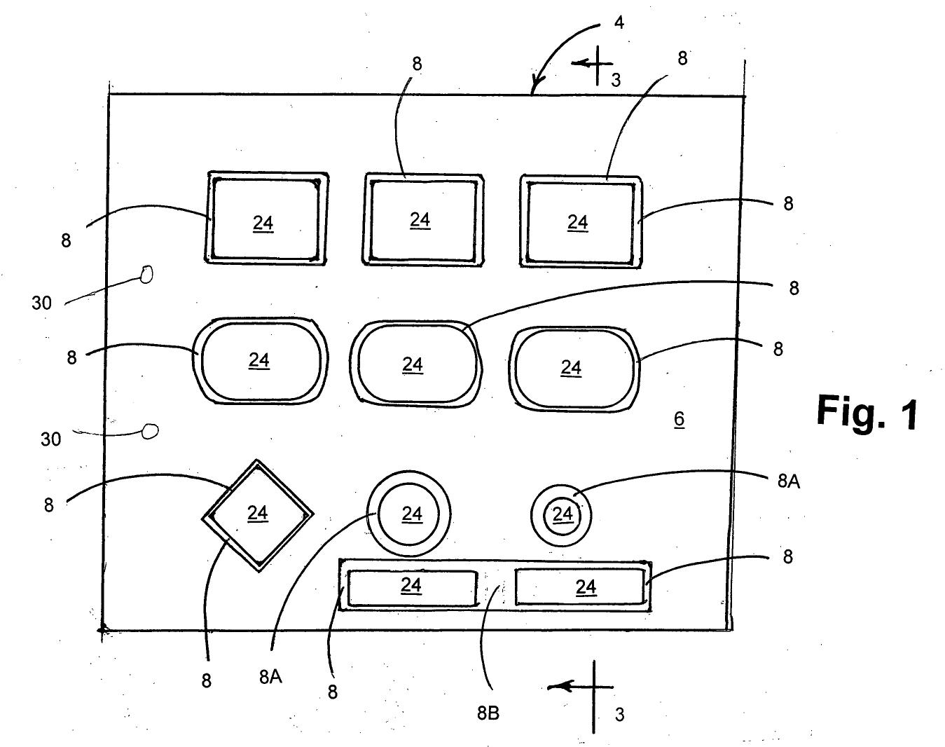

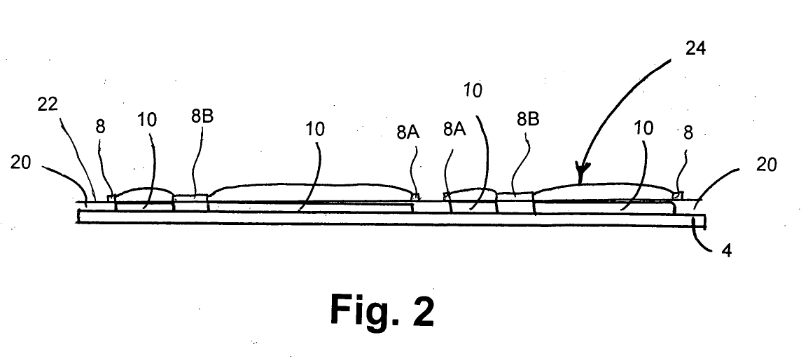

Referring now to FIGS. 1-3 wherein like reference numbers refer to like elements, FIGS. 1-3 depict the laminated display vehicle of the present invention.

A base layer 4 is paper in the depicted embodiment. Deposited on a top surface 6 of said paper are images 10. These images are typically photographs comprised of ink and are applied to the top surface 6 of paper backing 4 through conventional methods, such as offset commercial lithography. The photographs may be traditional, digital, or otherwise.

A film layer 20 is deposited over the top surface 6 of the base layer 4 and the images 10. Lamination of the depicted embodiment is by a separate machine, which uses hot rollers to laminate the film layer 20 over the paper backing 4 and images 10. In the depicted embodiment, a polyester film 1.2 mils thick, including on its bottom surface an adhesive layer that is 0.5 mils thick, is laminated onto the base layer 4, with the adhesive facing the top surface 6 of the paper backing 4 and the images 10. It is also within the scope the present invention that screen press printing can be used to coat a layer of material onto the top of the paper backing and image. Alternatively, it may be coated on an offset, digital or other printing press or device.

In the depicted embodiment, the coating layer is polyester. Polypropylene may also be used as a laminate. The paper substrate used in a depicted laminated embodiment is known in the art as “coated cover” or “board” and known as such to those with skill in the art. It is not a board per se, but rather paper of known stiffness and weight. It is amenable to printing in commonly used offset printing machines using rollers.

In the case of certain substrates, including certain types of paper and plastic, the film 20 may not be required. The apparatus and method of the present invention may also be executed with coated papers, which may or may not be combined with the base layer 4 or a film cover 20. These boards are known to those familiar with the art as “coated cover” or “board.”

On a top surface 22 of the film layer 20 are barriers or stops 8. The barriers or stops 8 substantially circumscribe the images 10 beneath in the depicted embodiment. It is within the scope of the present invention that the boundaries or stops substantially align with the edges of the images 10. However, it is also within the scope of the present invention that the barriers may vary from the edges of the images 10. Underneath the film laminate 20, the images 10 may be multiple, continuous, or otherwise. In the depicted embodiment, the images 10 are separated by borders. Likewise, the barriers 8A may be separated by a space between an edge of one image and an edge of the next image, or images may share a single boundary stop 8B. The boundary or stop 8 is an ink commercially available and designed as the flow stop for a polyurethane dome, as described below. It is applied in a screen printing manner familiar to those of skill in the art. In the depicted embodiment, a chemical doming repellant is used by those with skill in the art. It is equally within the scope of the present invention to use a plastisol ink or other inks. All that is required is that the stop ink has a different surface tension than the surface onto which the polyurethane will be deposited. This is because the polyurethane stops at a line where surface tension changes. It is against this border that the polyurethane “domes” to create a simulated three-D effect. Over the images 10 and within the borders of a particular boundary stop 8, the polyurethane is deposited in a lens or dome 24. The polyurethane, like the borders and film laminate, is clear. Polyurethane has the characteristic of drying with curved edges, which imparts a desirable three dimensional effect to the image underneath. The curved or domed edges of the polyurethane deposits 24 are created by the interaction of the polyurethane with the boundary stops 8, where the difference in surface tension of the underlying material stops further lateral flow of the liquid polyurethane.

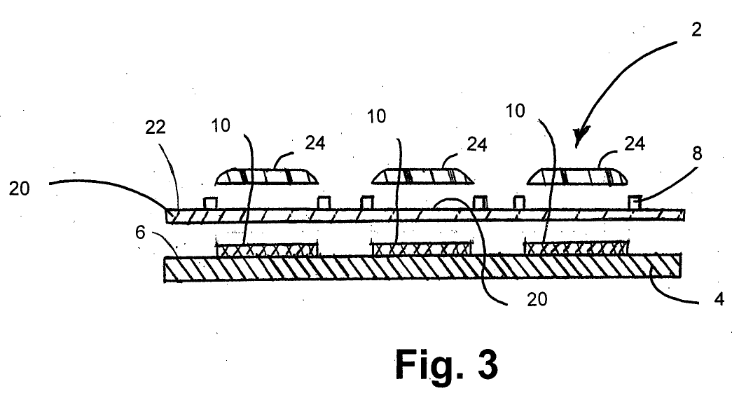

FIG. 1 illustrates in a top view a sheet backing material 4, such as paper. FIG. 1 illustrates that a variety of shapes and sizes or configurations may be used for display of the images 10. FIG. 3 further illustrates an example of a shared boundary stop 8B between two images underneath their polyurethane domes 24, as seen in the lower right hand corner. As will be apparent to those of skill in the art, the rapidly and economically produceable display or sample sheet as shown in FIG. 3 may be readily mounted in a display book, mounted on chip board, or used for a show room display. Perforations 30 allow multiple sheets to be assembled into a book.

The assembly method for the depicted embodiments is as follows. A variety of different, individual images are created. Each image 10 depicts a different sample of a floor covering, such as carpet. They are correlated with identifying information, such as a style ID number. They are arranged for printing on a single sheet or multiple sheets of paper backing 4 and printed as images 10 on a top surface 6 of the paper base layer 4. This is achieved with a standard off set printing machine such as those commonly available in the industry. Other printing processes are within the scope of the present invention.

A polyester film 20 is laminated onto the paper backing using rollers. The rollers are typically heated and under pressure. The amount of pressure exerted and the amount of heat applied to the polyester film and paper substrate are controllable by an operator. Again, such laminating machines are commercially available and familiar to those of skill in the art. The laminating technique used differs from that used for typical products to be subjected to a polyurethane doming process in that the lamination is permanent. That is, a user will not remove any portion of the laminate to use as a tag, label or sticker.

The laminated plastic film and paper substrate with the images between them will have a flow stop ink applied on a top surface. These include papers previously mentioned and known as coated cover or board sheets. In the depicted embodiment, this is done using a screen printing press using a standard flow stop inks and using ultraviolet curing techniques or air drying according to methods used with commercially available screen printing presses.

Finally, a dome is applied. A separate doming machine, such is the “AutoX” model commercially available through Development Associates in Rhode Island, may be used. Dome material is often polyurethane. However, other flowable materials that solidify to a clear dome within a flow stop boundary such as epoxy, are within the scope of the present invention. The sheets are aligned on a level glass conveyor and the doming machine uses a sensor to detect a boundary stop and deposit a preconfigured amount of liquid polyurethane at a preconfigured geometrical location corresponding to each of the images on the sheet and within a boundary of the flow stop ink border. The polyurethane, while still liquid, flows out to the boundary stop, stops there, and through a drying process solidifies into a “dome” having curved edges and imparting a desirable three-dimensional appearance to the image underneath.

It is within the scope of the present invention to omit the plastic laminate. Coated papers are known in the art. These include the papers previously mentioned and also known as SBS board or Carolina sheets. Using coated papers may be preferable to laminating for some end users who intend to use their sample boards longer term, since it is anticipated that under some uses plastic film laminate layers may discolor over time.

However, it is hitherto unknown in the art to apply polyurethane domes to paper products directly, whether they are coated or not. The prior art taught away from this technique because unacceptable amounts of moisture adhere to paper in a fashion that causes bubbles in the curing polyurethane. Accordingly, the doming polyurethane application process has been unreliable for paper alone because it has produced results of unacceptably varying quality. The inventor of the present domed sample vehicle, however, has determined that humidity may be controlled in order to achieve acceptable doming application results using only coated paper. After applying image ink to a coated paper backing, the sample sheets having an array of different images thereon are maintained and transported for flow stop barrier application and doming in a manner that preserves the ink image from scratching and in an atmosphere having a controlled humidity maintained within a range from about 10% to 40%. The flow stop ink is applied by a screen printer as described above. Thereafter, while continuing to maintain humidity control and preserving the image face from scratching, the sheets have the polyurethane applied, also described above.

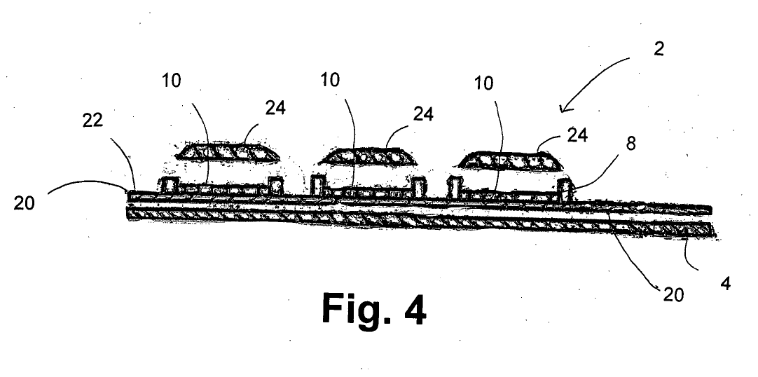

The resulting product is depicted in FIG. 4.

As those skilled in the art will understand, the method of assembling a laminated image can be repeated such that a display vehicle can be readily manufactured. In other words, sample sheets are assembled using the steps above, and, thereafter, the sample sheets are bound together to form the display vehicle. In the depicted embodiments, each sample sheet has a plurality of floor covering images, and the sample sheets are assembled to form a floor covering display vehicle.

The image laminate itself may be manipulated or transformed into a sample vehicle by means of die cutting, scoring or other equipment know by those in the art. Thereby the domed images may be further arranged or re-arranged.

FIG. 4 illustrates an alternative embodiment having a base layer 4 with a clay coating on its top surface 6. In the embodiment depicted in FIG. 4, a paper mill assembles and clay coats a paper, resulting in the backing 4 having a clay coating 20. A graphic image 10 is placed on top of the clay coating 20. A border or stop 8 is associated with the image 10 and arranged proximate to an edge of the image 10. Finally, a polyurethane dome 24 is placed over the image 10 and within the border 8.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. An image laminate comprising:
a backing layer;
an ink layer over a portion of a top surface of said backing layer, said ink layer comprising an image;
a polymer layer over at least said ink layer;
a boundary material substantially circumscribing said ink layer, said boundary material being deposited on a top surface of said polymer layer; and
a polyurethane lens also on said top surface of said polymer layer, said polyurethane lens being substantially over said ink layer and substantially within said boundary material.

2. The article of claim 1, wherein said polymer layer is a plastic film laminate.

3. The article of claim 1, further comprising at least one other image, said at least one other image being on top of said backing layer and beneath said polymer layer and also having a polyurethane lens thereover.

4. The article of claim 3, wherein a boundary of said first ink layer is separated from a nearest boundary of said second ink layer.

5. The article of claim 4, wherein said polymer layer is continuous over said first image and said second image.

6. A sample sheet having:
a backing;
a polymer laminate over said backing;
at least one image between a top surface of said backing and bottom surface of said laminate;
a boundary substantially circumscribing said at least one image;
a polyurethane top over said at least one image and within said boundary.

7. The article of claim 6, wherein said at least one image is a floor covering.

8. The article of claim 6, further comprising at least one other sheet in a book.

9. The article of claim 6, wherein said backing has two sides, each of said sides having at least one image, a laminate, a boundary and at least one polyurethane top thereover.

10. The article of claim 6, wherein said image is a scaled image.

11. The article of claim 6, further comprising at least one other image, said at least one other image being on top of said backing layer and beneath said polymer layer and also having a polyurethane lens thereover.

12. The article of claim 11, wherein a boundary of said first ink layer is separated from a nearest boundary of said second ink layer.

13. The article of claim 12, wherein said polymer layer is continuous over said first image and said second image.

14. A sample sheet having:
a paper backing;
a continuous polymer laminate over said paper backing;
a plurality of graphic images between a top surface of said paper backing and a bottom surface of said continuous polymer laminate;
an ink boundary substantially circumscribing each of said plurality of graphic images;
a polyurethane top over each of said plurality of graphic images and within said boundary, whereby said polyurethane top provides each of said plurality of graphic images with a simulated 3-D effect.

15. The article of claim 14, wherein said plurality of graphic images are images of floor coverings.

16. A method of making a laminated image comprising the steps of:
providing a backing layer;
imaging a top surface of said backing layer;
laminating a film over said backing layer and said image;
substantially circumscribing said image with a boundary on a top surface of said laminated film; and
depositing a clear polymer over said image and within said boundary.

17. A method of assembling a floor covering display vehicle comprising the steps of:
providing a plurality of sample sheets;
assembling a plurality of laminated images, said step including for each of said plurality of sample sheets the steps of:
providing a backing layer;
imaging a floor covering image onto a top surface of said backing layer;
laminating a film over said backing layer and said floor covering image;
substantially circumscribing said floor covering image with a boundary on a top surface of said laminated film; and
depositing a clear polymer over said floor covering image and within said boundary; and
binding together said plurality of sample sheets.
